(19) United States
(12) Patent Application Publication
(10) Pub. No.: US 2014/0073498 A1
(43) Pub. Date: Mar. 13, 2014

(54) Rotor Device, Centrifuge Bowl, and Centrifuge, and the Production Method Thereof

(71) Applicant: Eppendorf AG, Hamburg (DE)

(72) Inventor: Werner LURZ, Hamburg (DE)

(21) Appl. No.: 14/019,449

(22) Filed: Sep. 5, 2013

Related U.S. Application Data
(60) Provisional application No. 61/697,355, filed on Sep. 6, 2012.

(30) Foreign Application Priority Data
Sep. 6, 2012 (EP) 12 006 283.1

(51) Int. Cl. B04B 5/04

(52) U.S. Cl. CPC B04B 5/04
USPC 494/43; 427/256

(57) ABSTRACT

The invention relates to a rotor device of a centrifuge, in particular a laboratory centrifuge, implemented for rotation about an axis of rotation A in a fluid, having an inner region for accommodating a sample to be centrifuged, an outer wall having an outer surface around which fluid flows during rotation of the rotor device, wherein at least one surface section of the outer surface has a microchannel structure, the channels of which extend at a distance d of adjacent channels, where in particular d<2 mm. The invention also relates to a centrifuge bowl for accommodating a rotor device having microchannel structure, and a method for producing the rotor device and the centrifuge bowl.

The invention relates to a rotor device, a centrifuge bowl accommodating the rotor device, and a centrifuge, which has this rotor device and/or the centrifuge bowl, and the production method of these parts.

Centrifuges are used in particular as laboratory centrifuges for the purpose of separating samples having components of differing densities, e.g., in order to separate particles contained in fluids from the fluid or in order to separate liquids of different densities from one another. The mass inertia of the particles is utilized, which have a greater density (mass per volume) in comparison to the fluid surrounding them. By way of the rotation of the sample about an axis of rotation of the centrifuge, a centrifugal force is generated, by which the denser components within the sample are driven outwards radially, i.e., perpendicularly to the axis of rotation. In biochemical and biomedical laboratories, in this manner in particular macromolecules, living cells, or cell fragments are separated from liquids, or liquids of differing densities are separated from one another. The sample can be a solution of DNA in aqueous solution, for example. To carry out a centrifugation, the sample holder having the sample is placed in the region provided within the centrifuge rotor for accommodating the sample to be centrifuged. The sample is then rotated depending on the requirement at up to 14,000 rpm, for example. At such rotational speeds, for example, in the case of a sample consisting of an aqueous DNA solution, the DNA may be separated from the aqueous phase. Centrifuging using up to 500,000 rpm is designated as ultra centrifugation. Lipoproteins may thus be isolated from an aqueous solution, for example.

Because of these high rotational speeds, centrifuge rotors must be manufactured from a material which offers sufficient stability with respect to the occurring centrifugal forces. The rotors typically consist of aluminium, sometimes also of plastic, and have a high mass corresponding to the required strength. Because of their large surface area and the high speed, the rotors experience a high air friction, which is noticeable, on the one hand, in undesirable high heating of the rotor and therefore the rotated samples and, on the other hand, in increased power consumption of the centrifuge. It is therefore desirable to reduce the power loss of the centrifuges, which is caused by air friction and is related to a predetermined rotational speed.

The object of the present invention is to provide a rotor device for a centrifuge, a centrifuge bowl, and a centrifuge having at least one of these parts, and a method for the production thereof, wherein during use of the centrifuge or at least one of the parts, a lower power loss of the centrifuge, which is related to a predetermined rotational speed, results.

The invention achieves this object in particular by way of the centrifuge rotor according to Claim 1, the centrifuge bowl for accommodating the centrifuge rotor according to Claim 13, and the method for producing at least one of these components according to Claim 15. Preferred embodiments are the subject matter of the dependent Claims in particular.

The invention is based on measurements and computer simulations, in which it has surprisingly been established that in the case of large fixed-angle rotors, a power loss of greater than 500 W is produced only by air friction. It has been shown that almost all of the air resistance is generated by air friction on the rotor and on the bowl walls. Due to this air friction, the rotor heats up strongly at high rotational speeds and then must be counter cooled via the bowl wall in a complex manner. The air density in the bowl grows due to the counter-cooling and therefore the air friction in turn grows.

According to the invention, the contact surface of the centrifuge subjected to the fluid flow, in particular the outer surface of the rotor device and/or the inner surface of the centrifuge bowl, is at least sectionally provided with a microchannel structure. By way of the localization of the turbulent flow components within the channels, the energy exchange between the turbulent flow regions and the free flow at some distance from the outer surface is reduced, so that the fluid friction or the power loss of the centrifuge can be reduced down to approximately 10%. The optimization of the microchannel structure can, preferably depending on the requirements of the intended purpose and the rotational speeds of the centrifuge, be performed by adjusting various geometric parameters, which is described hereafter. The arrangement of channel structures on surfaces for friction reduction have been proposed after analyses of the skin of sharks in other fields of technology (Bechert, D W. et al.; Experiments on drag-reducing surfaces and their optimization with an adjustable geometry; J. Fluid Mech. 338 (1997), P. 59-87).

A channel structure, in particular equivalently also a microchannel structure, is designated in the scope of this invention as a plurality of channels, which preferably extend substantially in parallel, of the outer surface, which extend in particular at a distance d of adjacent channels of less than 2 mm. This distant d can be constant, but it can also change in particular along the longitudinal extension of adjacent channels, in particular change continuously. Two channels extending substantially in parallel are adjacent if a third channel does not extend between them or if the two channels are separated by a single partition wall, designated as a rib. The side walls of a rib thus form the side walls of adjacent channels. The width B of a rib can correspond in particular to the distance d.

Two fundamentally different forms of flow of a fluid are described as laminar flow and as turbulent flow in flow mechanics. Most flows which occur in the case of technical applications are turbulent. Turbulent flows typically have higher friction losses than laminar flows. The increased friction in the turbulent flow arises due to momentum transport transversely to the main flow direction in the boundary layer. The flow directly at the surface over which flow occurs is dominated by vortex structures, which transport high-energy fluid at the wall surface. This additional exchange of momentum—in comparison to laminar flow—is the reason for the increased wall friction in the turbulent boundary layer. The surface around which flow occurs is in particular a section of the outer surface of a rotor unit or the inner surface of a centrifuge bowl in the present case.

The microchannel structure is preferably adapted such that approximately or precisely the local Reynolds number is Re⁺=17. In this case

$${Re}^{+} = \frac{{u}_{τ} \cdot S}{v}$$

The individual symbols stand for the following variables:

ν—Characteristic kinematic viscosity of the fluid (m² s⁻¹). The kinematic viscosity of air is temperature dependent, and at room temperature is approximately ν=15 m² s⁻¹;

u_{τ}—Characteristic local shear velocity of the fluid in relation to the body (m s⁻¹), wherein

$${u}_{τ} = \sqrt{\frac{{T}_{w}}{ρ}} ,$$

where T_{w} is the local wall shear stress and ρ is the density of the fluid.

s—Channel width.

The relative resistance reduction RR is defined as RR=(FR₁−FR₂)/FR₂, wherein

FR₁ is the friction resistance of a surface having the microchannel structure and FR₂ is the friction resistance of a surface without the microchannel structure. The achieved value for RR is dependent on the Reynolds number Re⁺. RR as a function of the Reynolds number has a minimum at approximately Re⁺=17, i.e., the greatest resistance reduction is achieved at a local Reynolds number of 17.

A resistance reduction is significant in particular in those sections of a surface around which flow occurs, in which the greatest friction losses arise.

In general, the wall shear stress, i.e., the friction force, which a flow of a normal viscosity fluid (Newtonian fluid) exerts on a surface, can be characterized by:

T_{w}=μ*δu/δy,

wherein the wall shear stress acts tangentially to the contact surface. In this case, μ is the dynamic viscosity, u is the flow velocity with respect to the contact surface having incident flow, which becomes greater with increasing distance from the contact surface in the direction y perpendicularly away from the contact surface.

Above a viscous lower layer y⁺=uₜ*y/ν, the universal turbulent velocity distribution applies:

u⁺=1/k*ln y⁺+5,

wherein k=0.41 and u⁺=U₀/uₜ. In this case U₀ denotes the velocity of the free incident flow and uₜ denotes the shear velocity, which is defined as:

uₜ=\sqrt{T_{w}/ρ}

wherein ρ is the density of the fluid, and ν=μ/ρ.

On the top side of a vortex, which fills a channel, having the diameter D_{w}=2h=s, the following equation applies in the case of optimum resistance reduction

y⁺=u_{τ}*s/ν=17,

s and h as defined hereafter.

By experiment and simulation of typical laboratory centrifuges, the rotors and centrifuge bowls thereof, a possible approximation formula for calculating u_{τ} was developed to determine u_{τ} as a function of the velocity u₀ of the free flow

u_{τ}≈u₀/11.9.

The shear velocity u_{τ} is a measure of the occurring friction force. It may be ascertained, for example, by means of a finite element simulation and modelling of the complete flow around the surface in question, around which flow occurs. Therefore, the sections of elevated air friction may be ascertained on the basis of the shear velocity.

The rotor device preferably has a lower rotor section and preferably has an upper rotor section, which is arranged along the axis of rotation above the lower rotor section. In the case of proper use of the rotor device, the lower rotor section is arranged below the upper rotor section with respect to the direction of gravity. The lower rotor section and the upper rotor section can be separate parts, can be implemented as connected or connectable in particular, or can be integrally implemented. The lower rotor section and the upper rotor section are preferably connected by a middle rotor section, wherein the maximum diameter of the middle rotor section preferably corresponds to the maximum diameter of the rotor device Dₘₐₓ and preferably the maximum diameter of the middle rotor section is preferably greater than the maximum diameter of the upper rotor section and is preferably greater than the maximum diameter of the lower rotor section, wherein respectively the diameter in a rotational plane of the rotor device is meant.

The rotor device preferably has a region located radially on the inside and a region located radially on the outside. The region located radially on the inside comprises the sections of the rotor device which lie inside the imaginary cylinder located concentrically to the axis of rotation having the external diameter D_{A}=c*Dₘₐₓ, wherein Dₘₐₓ is the maximum diameter of the rotor device in a rotational plane perpendicular to the axis of rotation, and wherein preferably c is a number where 0.1<=c<=0.9, preferably 0.4<=c<=0.9, preferably 0.5<=c<=0.9, preferably approximately c=0.5. The region located radially on the outside comprises the sections of the rotor device which lie outside the region located radially on the inside.

The maximum diameter of the rotor device Dₘₐₓ is preferably between D1ₘₐₓ<=Dₘₐₓ<=D2ₘₐₓ, wherein preferably the lower limit D1ₘₐₓ is taken from the group of preferred values {10 cm, 20 cm; 30 cm; 50 cm; 100 cm}, and wherein preferably the upper limit D2ₘₐₓ is taken from the group of preferred values {20 cm, 30 cm; 50 cm; 100 cm; 300 cm}.

The at least one section which has the microchannel structure is preferably arranged in the upper rotor section. Particularly large shear velocities occur here in the case of rotor devices of centrifuges, as has been shown in finite element simulations. It is possible and preferable that the at least one section which has the microchannel structure is alternatively or additionally arranged in the lower rotor section. The at least one section which has the microchannel structure is preferably arranged in the region located radially outside of the rotor device, since the greater shear velocities also occur here in the calculated rotor forms; this is immediately comprehensible, because orbital velocities are higher in the outer region at equal angular velocity. Alternatively or additionally, however, it is also possible and preferable that the at least one section which has the microchannel structure is arranged in the region located radially on the inside of the rotor device. Because the microchannel structure is only sectionally situated on the surface around which the fluid flows, efficient consideration of reduction outlay and friction reduction is made in particular. This also applies for the inner surface of the centrifuge bowl, which is preferably provided with microchannels according to the invention.

The at least one section which has the microchannel structure is preferably arranged in the region of the surface around which the fluid flows, in particular the outer surface of the rotor device or the inner surface of the centrifuge bowl, in which, with respect to the surface A, a proportion A_{F} of 40%<=A_{F}/A<=60% of the greatest shear velocities occur. Preferably, 5%<=A_{F}/A<=95%, preferably 40%<=A_{F}/A<=60%, and particularly preferably 40%<=A_{F}/A<=60%. The expenditure for the provision of the microchannel structure is thus reduced, while the reduction of the air friction caused by the microchannel structure is achieved to a sufficient extent.

Preferably, substantially the entire outer surface of the rotor device is provided with a microchannel structure. The fluid friction can thus be reduced particularly strongly.

The channels are preferably implemented as depressions in the surface. This can be achieved by processing of the outer surface of the rotor device or the inner surface of the centrifuge bowl, for example, by means of ablation technologies, e.g., by means of machining, by means of laser ablation, by means of wet or dry etching, in particular with the aid of photolithographic methods. It is also possible and preferable for the channels to be formed by rib elements on the outer wall, between which the channels are implemented. Such ribs can be connected as additional material to the surface to be structured in an application method, for example, by vapour deposition of material onto the surface, for example, in particular with the aid of photolithographic methods, in particular by means of sputtering or CVD (chemical vapour deposition). Furthermore, it is preferable for the microchannel structure to be produced by printing a material, in particular a lacquer, onto the outer surface of the rotor device or the inner surface of the centrifuge bowl. The two geometrical structures which are produced by an ablation method and an application method may be non-differentiable. The microchannel structure of the surface can also be produced by fastening a film which is provided with a microchannel structure onto the surface and/or the inner surface.

The microchannel structure is preferably implemented such that adjacent channel walls are arranged at a distance s_{R} from one another, wherein the distance s_{R} is measured at the maximum height h—or alternatively half of the height h, for example, if a measurement at the maximum height is not advisable—of adjacent channel walls and parallel to the surface section with this channel or to the outer surface or inner surface, wherein the height h is measured starting from the point of lowest height of the channel in the direction perpendicular to the longitudinal direction of the channel and perpendicularly away from the outer surface of the rotor device, or away from the inner surface of the centrifuge bowl, wherein preferably

s1<=s_{R}<=s2,

wherein s1=(1−f)*s and s2=(1+f)*s, f is selected from the group of numbers {0.01; 0.02; 0.2; 0.5; 0.6; 0.7; 0.8; 0.9; 0.98; 0.99}, and

preferably

s=Re⁺*ν/u_{τ},

in particular

s=Re⁺*ν/(u₀/11.9),

wherein Re⁺ is the local Reynolds number for the rotating channel, ν is the kinematic viscosity of the fluid, and u₀ is an average incident flow velocity of the fluid with respect to the channel, wherein in particular the Reynolds number is Re⁺=17, and wherein in particular at room temperature, 21° C., the viscosity of air is ν=15*10̂−6 m²/s.

The channel width s is accordingly preferably selected as a function of the shear velocity which is to be expected in the section having the microchannel structure. The shear velocity is also dependent in particular on the revolution velocity of a point of the outer surface v=r*ω, ω is the angular velocity of the rotation and r is the distance of the point from the axis of rotation. The velocity u₀ of the free flow can be assumed to be u₀=v or u₀=0.5*v. In particular, the channel width s is accordingly preferably selected as a function of a predetermined shear velocity and/or a predetermined rotational speed.

The predetermined shear velocity can be that which is to be expected on average with respect to the typical rotational speeds, or which is to be expected with respect to the average of the higher rotational speeds of the centrifuge, wherein higher rotational speeds are to be understood as those in the range from 0.5 times or 0.75 times the maximum rotational speed up to the maximum rotational speed of the centrifuge and/or the rotor device, or which is to be expected with respect to the average of the maximum occurring shear velocities at maximum rotational speed, or with respect to the average of the rotational speeds expected most frequently for the operation of the rotor device and/or the centrifuge bowl and/or the centrifuge. The predetermined shear velocity can also be determined such that a maximum friction reduction is achieved in practical operation of a centrifuge thus designed. This can be ascertained, for example, experimentally or by numeric simulation. Preferably, at least one—or each—of the channel parameters described here {s; h; T; B; α; β} is selected depending on the predetermined shear velocity.

The local wall shear stress and therefore the shear velocity change with respect to the direction thereof and the absolute value thereof as a function of the position on the outer surface of the rotor device or the inner surface of the centrifuge bowl. The directions of the wall shear stress, the shear velocity, and the surface-proximal flow of the fluid are the same. An optimum resistance reduction is achieved if the channel width s is determined at each point along the longitudinal direction of the channel according to the equation s=Re⁺*ν/u_{τ}. A sufficient amount of the resistance reduction is already achieved, however, if the channel width approximates the optimum case. The channel width s can be constant over the longitudinal extension of a channel, for example, but is preferably variable over the longitudinal extension of a channel. In particular, the channel width is preferably selected to be smaller with increasing shear velocity. In particular, the channel width is preferably selected to be smaller with increasing shear velocity.

The channel width sᵢ at least in a first section of the outer surface of the rotor device is preferably less than the channel width sᵢᵢ in a second section of the outer surface of the rotor device, wherein the first section lies further radially outwards with respect to the axis of rotation than the second section. Since greater shear velocities typically occur further radially outwards, the resistance reduction can thus be optimized further.

The microchannel structure is preferably implemented such that adjacent channel walls are arranged at a distance s from one another, wherein the distance s is measured at the maximum height h of adjacent channel walls, or at the mean height, perpendicular to the longitudinal direction of the channel and parallel to the outer surface of the rotor device, wherein the height h is measured starting from the point of lowest height of the channel in the direction perpendicular to the longitudinal direction of the channel and perpendicularly away from the outer surface of the rotor device, wherein s is selected from a range for s with a lower limit s1 and an upper limit s2, so that s1<=s<=s2, wherein s1 is selected from the values {1.0 μm; 5.0 μm; 10.0 μm; 20.0 μm; 30.0 μm; 40.0 μm} and s2 is selected from the values {40.0 μm; 50.0 μm; 60.0 μm; 70.0 μm; 80.0 μm; 100.0 μm; 200.0 μm; 500.0 μm}.

A first distance of adjacent channel walls s_{inside} is particularly preferably provided in the region located radially on the inside of the rotor device, and a second distance s_{outside} is particularly preferably provided in the region located radially on the outside of the rotor device, wherein preferably s_{inside} is not equal to s_{outside}, and particularly preferably s_{inside}>s_{outside}, which results from the mentioned dependence on s(uₜ). In a particularly preferred case, which was modelled in a simulation of a typical laboratory centrifuge, 60 μm<=s_{inside}<=85 μm and/or 40 μm<=s_{outside}<60 μm. Optimum effects of friction reduction thus result. The mean distance sₘₑₐₙ of the channels on a rotor device is preferably 40 μm<=sₘₑₐₙ<=80 μm, preferably 50 μm<=sₘₑₐₙ<=70 μm, and particularly preferably 55 μm<=sₘₑₐₙ<=65 μm, preferably sₘₑₐₙ≈60 μm.

The depth T of a channel corresponds to the height h thereof. The height h of a channel corresponds to a height of the adjacent channel. The microchannel structure is preferably implemented such that the height h of a channel is selected from a range for h with a lower limit h1 and an upper limit h2, so that h1<=h<=h2, wherein h1=(1−f2)*s and h2=(1+f2)*s, f2 is selected from the group of numbers {0.2; 0.5; 0.6; 0.7; 0.8; 0.9}, preferably h=0.5*s, s as defined above.

The microchannel structure is preferably implemented such that the height h of a channel is selected from a range for h with a lower limit h1 and an upper limit h2, so that h1<=h<=h2, wherein h1 is selected from the values {2.0 μm; 5.0 μm; 10.0 μm; 20.0 μm; 30.0 μm; 40.0 μm} and h2 is selected from the values {40.0 μm; 50.0 μm; 60.0 μm; 70.0 μm; 80.0 μm; 100.0 μm; 200.0 μm; 300.0 μm}.

Preferably, B=0.02*s, wherein s is the distance of adjacent channel walls, as defined above. Optimum effects of friction reduction thus result. In a particularly preferred case, which was modelled in a simulation of a typical laboratory centrifuge, 60 μm<=s_{inside}<=85 μm and/or 40 μm<=s_{outside}<60 μm.

Preferably, h=0.5*s, wherein s is the distance of adjacent channel walls, as defined above. Optimum effects of friction reduction thus result. In a particularly preferred case, which was modelled in a simulation of a typical laboratory centrifuge, 30 μm<=h<=42 μm and/or 20 μm<=h<30 μm. The average depth Tₘₑₐₙ, which is preferably equal to the average height hₘₑₐₙ, of all channels of the rotor device is Tₘₑₐₙ≈30 μm.

The microchannel structure is preferably implemented such that the rib which separates two adjacent channels and thus forms the partition wall has a width B, which preferably corresponds to the distance d, wherein the width B is measured at the maximum height h—or alternatively at half of the height h—of the partition wall, perpendicularly to the longitudinal direction of the channel or rib and parallel to the outer surface of the rotor device or the inner surface of the centrifuge bowl, wherein B is selected from a range for B with a lower limit B1 and an upper limit B2, so that B1<=B<=B2, wherein B1 is selected from the values {0.05 μm; 0.1 μm; 0.5 μm; 1.0 μm; 10.0 μm} and B2 is selected from the values {0.5 μm; 1.0 μm; 1.5 μm; 3.0 μm; 5.0 μm; 10.0 μm; 50.0 μm; 100.0 μm}, wherein preferably B=0.02*s, wherein s is the distance of adjacent channel walls as defined above. In a particularly preferred case, which was modelled in a simulation of a typical laboratory centrifuge, 0.5 μm<=B<=4 μm and/or 1 μm<=B<2 μm. The width B is in particular equal to the distance d of adjacent channels.

The microchannel structure is preferably implemented such that the rib which separates two adjacent channels has at least one lateral surface, which encloses an acute angle α with a normal of the surface section of the outer surface, wherein preferably α is selected from a range for α with a lower limit α1 and an upper limit α2, so that α1<=α<=α2, wherein α1 is selected from the values {0.0°; 5.0°; 10.0°; 20.0°} and α2 is selected from the values {0.0°; 5.0°; 10.0°; 20.0°; 45.0°}, preferably α=0°. Optimum effects of friction reduction thus result. At least one lateral surface of the rib, or both lateral surfaces, preferably does/do not extend parallel to a rotational plane, which extends perpendicularly to the axis of rotation A. However, it is also possible and preferable that one or both lateral surfaces extend parallel to a rotational plane.

The microchannel structure is preferably implemented such that the rib which separates two adjacent channels has a substantially rectangular contour in a cross section observed perpendicularly to the longitudinal direction of the rib. The greatest effect of friction reduction thus results at 90° between channel base and channel wall, corresponding to the angle α=0°, corresponding to the most preferred case.

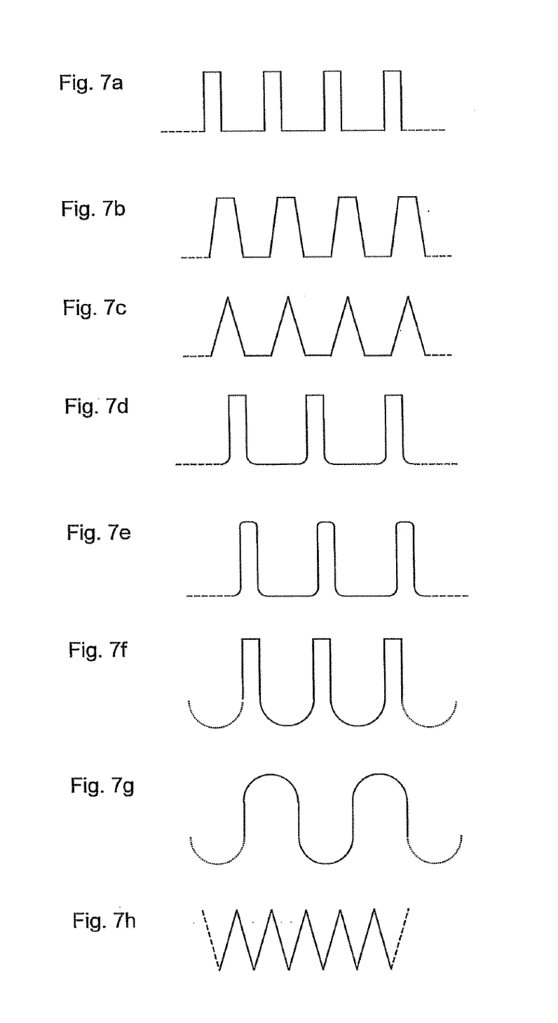

However, it is also possible and preferable for the contour of the rib and/or the ribs and/or the channel structure, in a cross section observed perpendicularly to the longitudinal direction of the rib, to have at least one of the following features: an edge at the transition between channel base and channel side wall; a rounding at the transition between channel base and channel side wall; an edge at the transition between channel side wall and rib outer wall; a rounding at the transition between channel side wall and rib outer wall; a linear or rounded channel base; a linear or rounded rib outer wall. The contour of the rib(s) and/or the channel(s) in this cross section can be triangular, in particular with respect to a triangle having equal sides. The contour of the channel structure can be zigzagged or wavy, having periodic or nonperiodic extension along the outer surface, perpendicularly to the longitudinal direction of the channel. Possible profiles of the channel structure are shown as examples in FIGS. 7a to 7h.

The longitudinal direction of the channel or the channels, and/or the orbit thereof, to which the channels of the microchannel structure of the surface section are aligned in parallel, is preferably implemented such that, at every point of the longitudinal extension thereof, it has an angle β to the surface of a rotational plane which extends perpendicularly to the axis of rotation. Preferably, β is not equal to zero. However, it is also possible and preferable that β=0, at least sectionally or in the entire region of the surface section which has the microchannel structure, or in particular the entire surface which has the microchannel structure.

Preferably, β is substantially constant over the entire section which has the microchannel structure. Independently thereof, β is selected from a range for β with a lower limit β1 and an upper limit β2, so that β1<=β<=β2, wherein β1 is selected from the values {0.0°; 5.0°; 10.0°; 20.0°} and β2 is selected from the values {0.0°; 5.0°; 10.0°; 20.0°; 45.0°; 60°}. Optimum effects of friction reduction thus result.

For laboratory centrifuges, ascertained by a finite element simulation, the ranges of preferably 5°<=β<=20°, 7°<=β<=15°, and particularly preferably 7°<=β<=12°, particularly preferably β≈9°, result. In addition to a calculation by simulation, in particular a finite element simulation, the angle β may also be experimentally determined, e.g., by the China clay method, which is a kaolin spraying method, or by smoke visualizations. The direction of the shear velocity corresponds in particular to the direction of the surface-proximal fluid flow.

The microchannel structure is preferably implemented such that at least two adjacent channels differ in at least one parameter for determining the channel geometry, wherein this parameter is selected from the group of parameters {s; h; T; B; α; β}. At least one of these parameters, or all of these parameters, can change along the longitudinal extension of a channel or rib, or can be constant.

The microchannel structure is preferably implemented such that the predetermined longitudinal direction of the channels is adapted to the direction of the fluid flow which flows past this surface section, in particular corresponds to the locally applied direction of the wall shear stress or the shear velocity, and in particular deviates from the concentric revolution direction, with which each point of the outer surface rotates in a rotation plane perpendicular to the axis of rotation.

The inner region of the rotor device can have a holding device for holding laboratory sample vessels, in particular closable sample tubes. The holding device can have a fixed angle with respect to the axis of rotation A of the rotor device during the rotation, wherein the holding device can also be implemented for adjustment of this angle by the user in this case. Such a rotor device is designated as a fixed-angle rotor. The holding device can also have an angle which is variable during the rotation with respect to the axis of rotation A of the rotor device, in that the holding device is implemented for the purpose of letting the sample vessels pivot radially outwards about a pivot axis perpendicular to the axis of rotation A, following the centrifugal force and/or gravity. Such a rotor device is designated as a swing-out rotor.

The rotor device is particularly preferably a fixed-angle rotor. However, it is also possible and preferable for the rotor device to be a swing-out rotor, which has a holding device having at least one, preferably three, four, or more cup elements, wherein a cup element is mounted so it is rotatable about a pivot axis on the base part of the rotor device. The base part is preferably arranged centrally on the axis of rotation A of the rotor device, preferably implemented rotationally symmetrical to the axis of rotation A. A cup element is implemented to accommodate at least one sample to be centrifuged. The at least one cup element has an outer surface having at least one surface section which has a microchannel structure. It is also possible and preferable for the swing-out rotor to have an enclosure device, which partially or completely encloses the holding device for the samples, on the one hand, encloses it partially or completely in the circumferential direction about the axis of rotation and/or encloses it on top and/or on the bottom partially or completely. The surface section having the microchannel structure can be arranged on the outer side of the enclosure device in this case.

The rotor device or the enclosure device preferably has an outer wall section which is shaped like a cylinder, and which in particular bears this surface section having microchannel structure. A cylindrical shape may be provided particularly simply with a microchannel structure, the channels of which extend at a distance d of adjacent channels in particular of less than 2 mm.

The rotor device can have a cover device, using which the inner region of the rotor device can be covered and/or closed. The cover device can have a closure element, using which the cover is fastenable on the rotor device. The cover device and/or the closure element can have an outer surface having at least one surface section which has a microchannel structure, the channels of which extend at a distance d of adjacent channels of less than 2 mm.

The surface section which has a microchannel structure, in particular the surface section of the outer surface of the rotor device and/or the surface section of the inner surface of the centrifuge bowl, preferably revolves partially or completely about the axis of rotation. A channel therefore preferably has in particular the shape of an open loop or preferably a closed loop. The microchannel structure preferably has the shape of a shell, which is respectively preferably implemented rotationally symmetrical to the axis of rotation A or, alternatively, is preferably implemented as non-rotationally symmetrical to the axis of rotation A.

Furthermore, the invention relates to the centrifuge bowl for accommodating a rotor device according to one of the preceding claims, having an inner wall having an inner surface, around which the fluid flows during rotation of the rotor device, wherein the inner surface at least sectionally has a microchannel structure, the channels of which extend—in particular substantially parallel to one another—at a distance d of adjacent channels of less than 2 mm. The inner surface of the centrifuge bowl, and/or the centrifuge bowl itself, is preferably manufactured from a metal, in particular a steel, or from plastic, or from ceramic, or has such a material. The centrifuge bowl can be a component assembled from one or more parts, which partially or completely encloses the end of a volume, which contains the fluid, in which the rotor device rotates. At least one section of a side wall of the centrifuge bowl is preferably implemented for the purpose of enclosing the axis of rotation A concentrically in the form of a hollow cylinder. The side wall of the centrifuge bowl is preferably implemented for the purpose of enclosing the axis of rotation A concentrically in the form of a hollow cylinder. This hollow-cylindrical region preferably has an inner surface having a microchannel structure, which preferably extends partially or completely about the axis of rotation. The centrifuge bowl can have a base wall, which can have an opening, through which the drive shaft of the rotor device can be guided into the inner volume of the centrifuge bowl. The centrifuge bowl can have a cover wall.

Furthermore, the invention relates to the centrifuge having a rotor device according to the invention and/or the centrifuge bowl according to the invention. The centrifuge is preferably a laboratory centrifuge, in particular for the centrifugation of chemical, biochemical, biological, and/or medical samples. The centrifuge is preferably a tabletop device having a total volume of less than 0.5 m³, wherein the total volume is considered to be the volume of the smallest cuboid which can completely receive the laboratory centrifuge.

The centrifuge preferably has a bearing device for the rotationally movable mounting of the rotor device according to the invention within the centrifuge bowl according to the invention. The bearing device can comprise a ball bearing, roller bearing, or friction bearing. Furthermore, it can have a rotating shaft, which is coincident with the (imaginary) axis of rotation.

Furthermore, the centrifuge can have an electrical control unit, in particular a program-controlled control unit, by which the operation of the centrifuge is controlled. The centrifuge can have a data memory device and/or a computing unit, e.g., a CPU or a microprocessor for processing/storing digital data. An adapted set of control data is preferably stored or is storable later in the data storage device. This data set is preferably adapted such that the temperature in the interior of the centrifuge, and/or the velocity of the centrifuge, are set to predetermined values, which are then automatically selected by the user of the centrifuge or the control program of the centrifuge, and are optimally selected in particular depending on the choice of the user. The data set contains control data, in the case of which, adapted to the present microchannel structure of the rotor device and/or the centrifuge bowl, a minimum air friction occurs between fluid in the interior of the centrifuge and the surface of the rotor device and/or the centrifuge bowl. These values can be ascertained by calculation, in particular a finite element simulation, and/or by experiments, wherein the air friction can be measured via the occurring waste heat, for example.

The centrifuge preferably has a housing device, which shields the components thereof, in particular the centrifuge bowl, partially or completely with respect to the surroundings. The housing device preferably has a cover device, by which the interior of the centrifuge can be opened and securely closed. The centrifuge preferably has a means for cooling the centrifuge bowl and therefore indirectly for cooling the rotor device. This can be a heat exchange means, e.g., a cooling fluid, which flows around the parts to be cooled and removes the heat, in particular the occurring fluid friction heat, which occurs between fluid in the centrifuge and the outer surface of the rotor device and/or the inner surface of the centrifuge bowl.

The centrifuge can also have a user interface, e.g., a display screen, touchscreen, or other input or output elements, via which the user can set the most important operating parameters, in particular the rotational speed(s), the centrifuging time(s), and/or centrifuging sequences, which centrifuging sequence is designated by a specific rotational speed and/or centrifuging time, or via which the user can select a centrifuging program or can establish the parameters of a centrifuging program, wherein a centrifuging program can contain the rotational speed(s), the centrifuging time(s), and/or centrifuging sequences, as well as break times, the absolute starting time and/or ending time, the chronologically constant or variable cooling and/or temperature-control setting of the inner region of the rotor device for accommodating the samples, and the like.

The centrifuge can have a sensor device for detecting the actual revolution velocity and/or vibrations. It can have an electrical regulating unit for regulating the rotational speed as a function of the measured value. Possible measured rotational speeds and/or accelerations/vibrations which exceed a tolerance value can, for example, cause the immediate deceleration of the rotation to a tolerable rotational speed or to zero.

The centrifuge is preferably a laboratory centrifuge, which reaches maximum rotational speeds of up to 25,000 rpm. The centrifuge is preferably a high-speed centrifuge, which reaches maximum rotational speeds of up to 50,000 rpm. Preferably, the centrifuge is an ultra centrifuge, which reaches maximum rotational speeds of up to 500,000 rpm, in particular if the rotor device thereof rotates in a vacuum. The design according to the invention having microchannel structure can also reduce the power loss of the centrifuge in the latter case.

Furthermore, the invention relates to the method for producing a rotor device according to the invention or the centrifuge bowl according to the invention, wherein the microchannel structure is produced by surface processing, in particular by an ablation method or an application method, as explained above, or by a casting method.

Preferred features of the centrifuge bowl according to the invention and the centrifuge according to the invention can, where reasonable, be derived from the description of the preferred features of the rotor device according to the invention, in particular with respect to the formation of the microchannel structure.

Further preferred embodiments of the rotor device according to the invention, the centrifuge bowl according to the invention, and the method according to the invention result from the following description of exemplary embodiments in conjunction with the figures and the description thereof. Identical components of the exemplary embodiments are identified by substantially identical reference signs, if this is not otherwise described or does not otherwise result from context. In the figures:

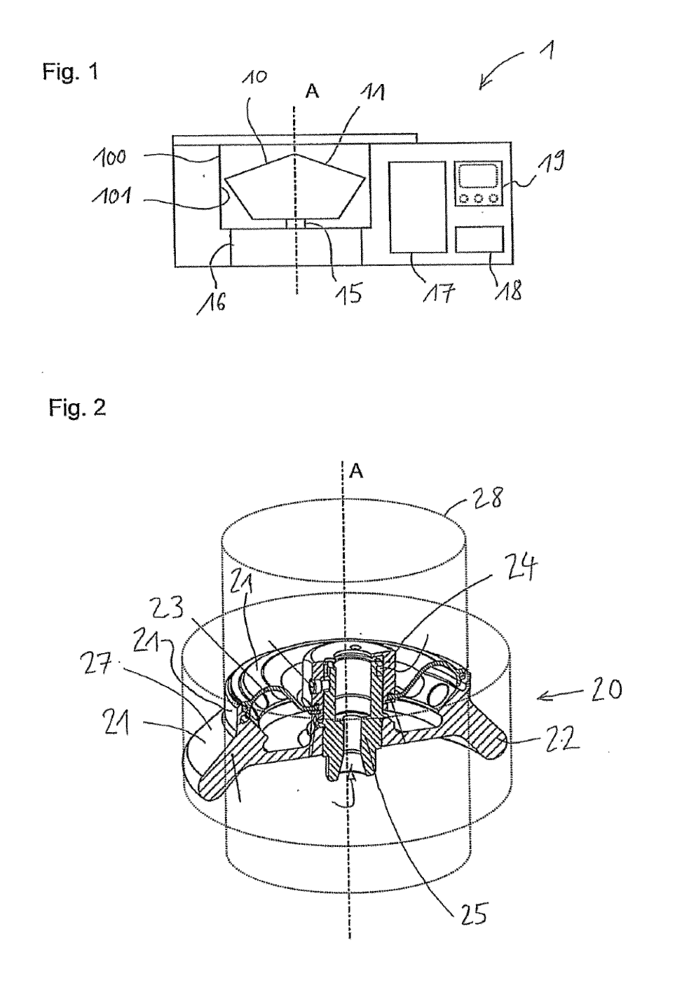

FIG. 1 schematically shows an exemplary embodiment of a centrifuge according to the invention, which has a rotor device and a centrifuge bowl according to preferred embodiments according to the invention.

FIG. 2 is the perspective view of an exemplary embodiment of the rotor device according to the invention, which is in section in this view along a plane which contains the axis of rotation A.

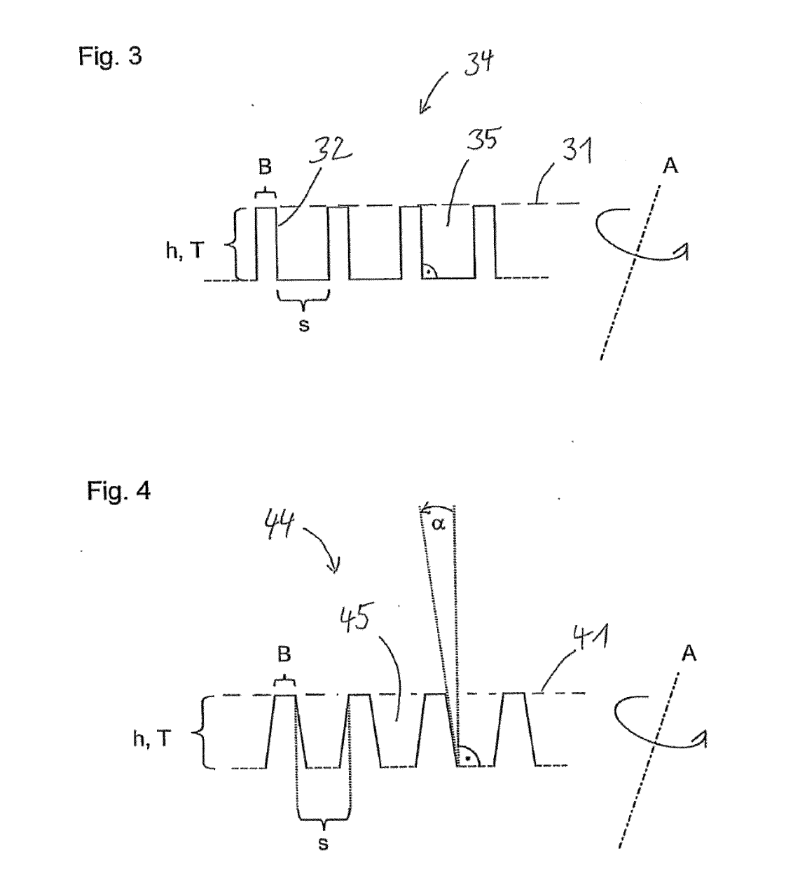

FIG. 3 shows a cross section observed perpendicularly to the longitudinal direction of the rib through the microchannel structure of a surface section of the outer surface of a rotor device according to the invention according to a preferred embodiment.

FIG. 4 shows a cross section observed perpendicularly to the longitudinal direction of the rib through the microchannel structure of a surface section of the outer surface of a rotor device according to the invention according to a further preferred embodiment, in a cross section observed perpendicularly to the longitudinal direction of the rib.

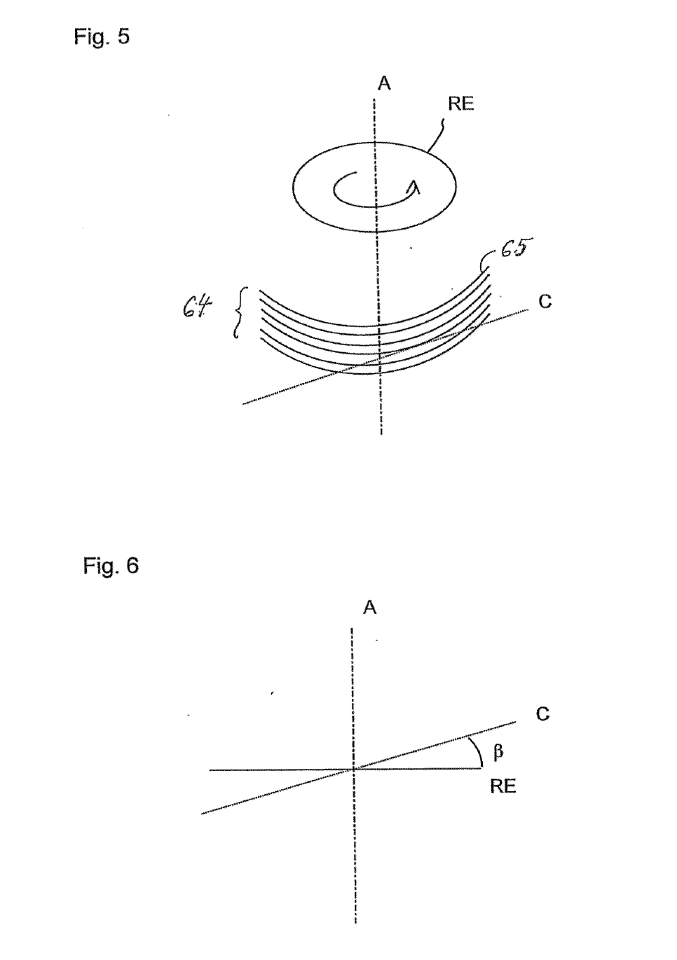

FIG. 5 shows a perspective view of a microchannel structure of a surface section of the outer surface of a rotor device according to the invention according to a further preferred embodiment.

FIG. 6 shows a diagram which describes the location of the angle β, which one channel of a microchannel structure, according to an embodiment according to the invention, encloses at the point of the longitudinal extension thereof with a rotation plane Re+, which is perpendicular to the axis of rotation.

FIGS. 7a, 7b, 7c, 7d, 7e, 7f, 7g, and 7h each show a cross section through the microchannel structure according to a preferred embodiment in each case of the invention, wherein the cross section is observed perpendicularly to the longitudinal direction of the rib.

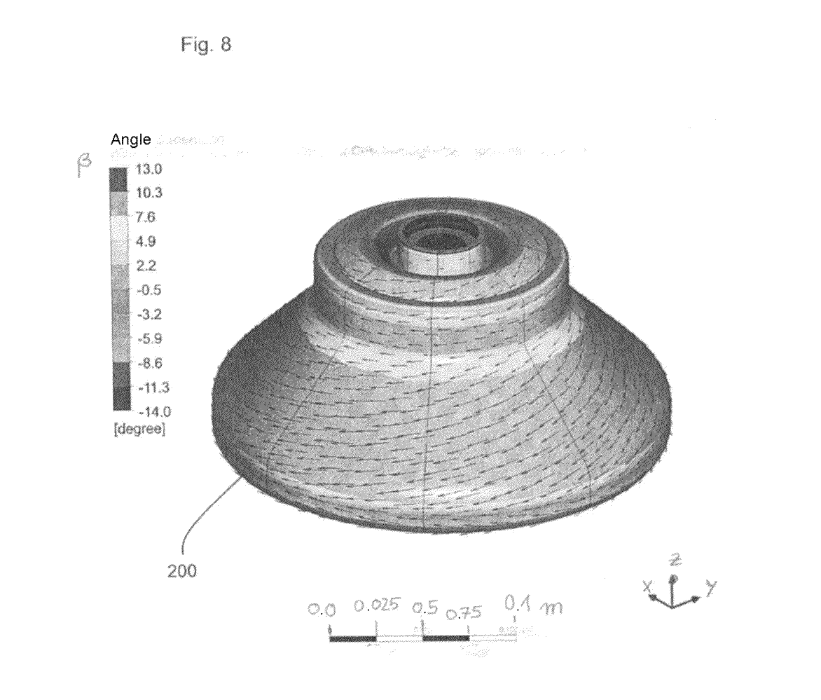

FIG. 8 shows a perspective view of a rotor device according to the invention according to a further exemplary embodiment, in which the shear velocities have been ascertained by a finite element simulation, wherein the directions of these local shear velocities are shown as arrows.

FIG. 1 shows a laboratory centrifuge 1, in the present case a tabletop device to be arranged on a work surface, which has a rotor device 10 and a centrifuge bowl 100. The rotor device has an outer surface 11, the centrifuge bowl has an inner surface 101. The rotor device is connected via a shaft 15 to a drive device 16, which can have an electric motor. Furthermore, the centrifuge has a cooling device 17, using which the centrifuge bowl 100 is cooled in a regulated manner in operation. The fluid, air here, in the inner volume of the centrifuge bowl is cooled, and the rotor device, which rotates in the inner volume of the centrifuge bowl and heats up the fluid and itself via the air friction, is also cooled by the cooling of the centrifuge bowl. The centrifuge also has an electrical control unit 18. The control unit regulates the drive device to bring the rotational velocity of the rotor device at the predetermined acceleration to the rotational speed desired by the user, and also to slow it down again after passage of the predetermined centrifugation time. The user performs the inputs via a user interface 19 of the centrifuge.

FIG. 2 shows an exemplary embodiment of a rotor device 20 according to the invention, which is in section along a plane which contains the axis of rotation A in this view. The rotor device 20 extends concentrically to the axis of rotation A and substantially rotationally symmetrical therewith, whereby an imbalance is prevented. The rotor device 20 has a base body 22 made of aluminium, for example, a cover section 23, which cover encloses the inner region of the rotor device, and a closure element 24, using which the cover section 23 arranged in the closure position can be securely fastened on the drive shaft 25, on which the base body 22 is also securely fastened.

The rotor device 20 is implemented as a fixed-angle rotor. The rotor device 20 has a holding device for holding tubular sample vessels, the tube containers of which are inserted through the openings of the holding frame of the holding device, and the vessel caps of which are supported on the holding frame, so that the sample vessels are securely held by the holding device under the effect of gravity and centrifugal force.

The outer surface 21 of the rotor device 20 has a surface section 27. This has a microchannel structure for reducing the air friction, as is described in the following figures, for example. The surface section having the microchannel structure is arranged in a region located radially on the outside, which lies outside the imaginary cylinder 28, which is located concentrically to the axis of rotation, having the external diameter D_{A}=0.75*Dₘₐₓ, and inside the cylinder 29, which is located concentrically to the axis of rotation, having the diameter Dₘₐₓ, wherein Dₘₐₓ is the maximum diameter of the rotor device in a rotational plane perpendicular to the axis of rotation. The other regions of the outer surface 21 of the rotor device preferably also have a microchannel structure.

FIG. 3 shows a cross section observed perpendicularly to the longitudinal direction of the rib through the microchannel structure of a surface section of the outer surface 31 of a rotor device according to the invention according to a preferred embodiment. The channels of the microstructure are at equal distances d=s from one another and extend parallel to one another. The channels are implemented as depressions of the outer surface 31.

The optimum values for the channel distance s may be determined via the equation

s=Re⁺*ν/u_{τ}, and Re⁺=17,

and the shear velocity u_{τ}, preferably also the angle β thereof, is determined by a finite element simulation. The result of such a simulation is shown with respect to a rotor device 200 designed according to the invention according to an exemplary embodiment in FIG. 8. This rotor device has a maximum external diameter Dₘₐₓ of 24.5 cm. The predetermined rotational speed was 15,000 rpm. In this way, for the predetermined rotational speed of the rotor device, i.e., this maximum rotational speed, the—in particular maximum—shear velocities can be ascertained depending on the position on the outer surface of the rotor device—i.e., the local shear velocities, in particular the absolute values and directions thereof.

In the simulation in FIG. 8, in particular the angle β was specified, which the surface-proximal flow, and therefore the shear velocity, and therefore the shear stress, has at every surface point of the surface of the rotor device. Over large parts of the surface, in regions of the surface located concentrically about the axis of rotation, in particular regions located radially between the axis of rotation and the outermost wall, which extend at an angle not equal to zero to the axis of rotation, this angle β is between 7.6° and 10.3°, and is therefore 9° in a good approximation. In the surface regions further inwards and outwards, which enclose angles of approximately zero with the axis of rotation in particular, i.e., extend substantially parallel to the axis of rotation, the angle β can be, for example, between 7.6° and −14.1°, or—in the innermost region here—also sometimes between 10.3° and 13°.

The calculation in the simulation according to FIG. 8 is performed, for example, in consideration of a sufficiently small distance dₐ, for example, dₐ=1 μm, measured perpendicularly to the outer surface of the rotor device, for the following reason: The boundary layer theory states that in the case of a body flow, the flow velocity directly on the body surface must be equal to zero, otherwise there would also be no friction. Therefore, if the distance to the surface were set equal to zero in the computing program in the ascertainment of the velocity vectors, all velocities would result as zero. To visualize a velocity field, one must thus leave a sufficiently small distance between surface and computing plane, to obtain finite values for the velocity vectors at all. If one increases this distance, substantially only the absolute value of the velocity changes in accordance with the boundary layer profile. The shear stress behaves differently. It is a measure of the friction and is therefore greatest directly at the surface, wherein the direction thereof corresponds to those of the velocity vectors.

In the example of FIG. 3, a value u_{τ}=5.0 m/s results in the region located radially on the outside of the rotor device 20 and a value u_{τ}=3.5 m/s results in the region located radially on the inside. Therefore, the optimum value for the channel distance s in the region located radially on the outside is s_{outside}=51 μm and in the region located radially on the inside is s_{inside}=73 μm. The optimum channel depth h=T is set at T=0.5*s, i.e. T_{outside}=26 μm and T_{inside}=36 μm. The optimum distance between the channels d=B, and therefore the width B of the ribs which separate adjacent channels, results as B=0.02*s, and therefore as B=1.0-1.5 μm. The angle between a channel wall 32 and a normal to the outer surface 31 encloses an angle α=0° here. This corresponds to a preferred embodiment for α.

FIG. 4 shows a cross section through the channel structure of a surface section of the outer surface 41 of a rotor device according to the invention according to a further preferred embodiment. The channel walls enclose an angle α>0° with the normals to the outer surface 41 here, specifically in particular an acute angle, i.e., α<90°, and in the present case approximately α=7°. This also corresponds to a preferred embodiment for α, because such channels may be manufactured more easily, for example, by means of laser ablation, than those having vertical walls (α=0°).

FIG. 5 shows a perspective view of a microchannel structure of a surface section of the outer surface of a rotor device according to the invention according to a further preferred embodiment. The microchannel structure 64 has channels 65, which extend parallel to an orbit about the axis of rotation and parallel to one another at a distance d of adjacent channels of less than 1 mm. An orbit can revolve in general completely or partially about the axis of rotation. A tangent C on the orbit is also a tangent C on the channel in the longitudinal direction. FIG. 6 shows a diagram which describes the location of the angle β, which a channel of the microstructure, according to the embodiment according to the invention, encloses at a point of the longitudinal extension thereof, and therefore with respect to this tangent C, with a rotation plane Re+, which is perpendicular to the axis of rotation. The optimum value for β, at which the air friction of the outer surface of the rotor device 21 is optimal, was calculated by means of a finite element simulation as β=9°. The angle β preferably varies along the longitudinal direction of a channel. Preferably, at least one of the parameters s, B, T also varies along the longitudinal direction of a channel.

The effect of the angle α of a side wall of the rib with the normal to the outer surface on the air friction can be estimated by means of the approximation equation

Δ=−0.00003*Φ²−0.0583*Φ+10,

wherein Φ=90°−α. A is the relative resistance reduction in percent, as a function of the flank angle Φ or α of the partition wall. The channels in the relevant surface section are arranged accordingly on the outer surface of the rotor device.

FIGS. 7a, 7b, 7c, 7d, 7e, 7f, 7g, and 7h each show a cross section through the microchannel structure according to a respective preferred embodiment of the invention, wherein the cross section is observed perpendicularly to the longitudinal direction of the rib/channel. The contour of a rib or a channel in this cross section or the profile is preferably rectangular (FIG. 7a and FIG. 3), has angled lateral surfaces (FIG. 7b and FIG. 4), is triangular, or the profile is partially zigzagged (FIG. 7c) or is completely zigzagged or is made of equilateral triangles in a row (FIG. 7h), has rounded edges between lateral surfaces of the channel and the channel base (FIG. 7d), and/or has in particular in addition thereto, rounded edges between outer wall of the rib and side walls of the rib (FIG. 7e), has a rounded channel base, in particular having a circular contour (FIG. 7f), and/or has in particular in addition thereto a rounded outer wall of the rib, in particular having a circular contour (FIG. 7g), wherein the profile can be corrugated. The features of these profiles can also be combined.

1. Rotor device (10; 20; 200) of a centrifuge (1), in particular a laboratory centrifuge, implemented for rotation about an axis of rotation A in a fluid, having
an inner region for accommodating a sample to be centrifuged,
an outer wall having an outer surface (21; 31; 41), around which the fluid flows during rotation of the rotor device,
wherein at least one surface section of the outer surface has a microchannel structure (34; 44; 64), the channels (35; 45; 65) of which extend in particular at a distance d of adjacent channels, in particular where d<2 mm.

2. Rotor device according to claim 1, characterized in that the channels are implemented as depressions in the outer wall of the rotor device and/or as rib elements on the outer wall, between which the channels are implemented.

3. Rotor device according to claim 1, characterized in that the channels are arranged such that they each extend substantially in the longitudinal direction parallel to the direction of the wall shear stress, which results from the friction of the fluid on the outer wall when the fluid flows along the outer surface at a predetermined rotational speed of the rotating rotor device.

4. Rotor device according to claim 1, characterized in that a channel has in each case two adjacent channel walls, which are arranged at a distance s from one another, wherein the distance is measured at the maximum height h of adjacent channel walls, perpendicular to the longitudinal direction of the channel and parallel to the outer surface of the rotor device, wherein the height h is measured originating from the point of lowest height of the channel in the direction perpendicular to the longitudinal direction of the channel and perpendicularly away from the outer surface of the rotor device, wherein s is selected from a range for s having a lower limit s1 and an upper limit s2, so that s1<=s<=s2, wherein s1 is selected from the values {1.0 μm; 5.0 μm; 10.0 μm; 20.0 μm; 30.0 μm; 40.0 μm} and s2 is selected from the values {40.0 μm; 50.0 μm; 60.0 μm; 70.0 μm; 80.0 μm; 100.0 μm; 200.0 μm; 500.0 μm}.

5. Rotor device according to claim 1, characterized in that adjacent channel walls are arranged at a distance s_{R} from one another, wherein the distance is measured at the maximum height h of adjacent channel walls, perpendicular to the longitudinal direction of the channel and parallel to the outer surface of the rotor device, wherein the height h is measured originating from the point of lowest height of the channel in the direction perpendicular to the longitudinal direction of the channel and perpendicularly away from the outer surface of the rotor device, wherein
s1<=s_{R}<=s2,
wherein s1=(1−f)*s and s2=(1+f)*s, f selected from the group of numbers {0.2; 0.5; 0.6; 0.7; 0.8; 0.9}, and
s=Re⁺*ν/(u⁺), wherein Re⁺ is the local Reynolds number for the rotating channel, ν is the kinematic viscosity of the fluid, and u⁺ is the shear velocity at a predetermined rotational speed at the location of the distance determination, wherein in particular the Reynolds number is Re+=17 and wherein in particular ν=15*10̂−6 m²/s.

6. Rotor device according to claim 1, characterized in that the height h of a channel is selected from a range for h having a lower limit h1 and an upper limit h2, so that h1<=h<=h2, wherein h1 is selected from the values {2.0 μm; 5.0 μm; 10.0 μm; 20.0 μm; 30.0 μm; 40.0 μm} and h2 is selected from the values {40.0 μm; 50.0 μm; 60.0 μm; 70.0 μm; 80.0 μm; 100.0 μm; 200.0 μm; 300.0 μm}.

7. Rotor device according to claim 1, characterized in that the height h of a channel is selected from a range for h having a lower limit h1 and an upper limit h2, so that h1<=h<=h2, wherein h1=(1−f2)*s and h2=(1+f2)*s, f2 is selected from the group of numbers {0.2; 0.5; 0.6; 0.7; 0.8; 0.9}, preferably T=0.5*s.

8. Rotor device according to claim 1, characterized in that the rib which separates two adjacent channels has a width B which corresponds to the distance d, wherein the width B is measured at the maximum height h of the partition wall, perpendicular to the longitudinal axis of the rib and parallel to the outer surface, wherein the height h is measured originating from the point of lowest height of the channel in the direction perpendicular to the longitudinal direction of the channel and perpendicularly away from the outer surface of the rotor device, wherein B is selected from a range for B having a lower limit B1 and an upper limit B2, so that B1<=B<=B2, wherein B1 is selected from the values {0.01; 0.02; 0.05 μm; 0.1 μm; 0.5 μm; 1.0 μm; 10.0 μm} and B2 is selected from the values {0.5 μm; 1.0 μm; 1.5 μm; 3.0 μm; 5.0 μm; 10.0 μm; 50.0 μm; 100.0 μm}.

9. Rotor device according to claim 1, characterized in that the rib which separates two adjacent channels has at least one lateral surface which encloses an acute angle α with a normal of the surface section of the outer surface, wherein preferably α is selected from a range for α having a lower limit α1 and an upper limit α2, so that α1<=α<=α2, wherein α1 is selected from the values {0.0°; 5.0°; 10.0°; 20.0°} and α2 is selected from the values {0.0°; 5.0°; 10.0°; 20.0°; 45.0°}, preferably α=0°.

10. Rotor device according to claim 1, characterized in that the rib which separates two adjacent channels has a substantially rectangular contour in a cross section observed perpendicularly to the longitudinal direction of the rib.

11. Rotor device according to claim 1, characterized in that at least two adjacent channels differ in at least one parameter for determining the channel geometry, wherein this parameter is selected from the group of parameters {s; h; T; B; α; β}.

12. Rotor device according to claim 1, characterized in that the channels are arranged such that the longitudinal direction thereof deviates from the concentric revolution direction, with which each point on the outer surface rotates in a rotation plane perpendicular to the axis of rotation.

13. Rotor device according to claim 1, characterized in that it has a cylindrical outer wall section, which bears this surface section having the microchannel structure.

14. Centrifuge bowl (100) for accommodating a rotor device (10; 20) according to claim 1, having
an inner wall having an inner surface (101), around which fluid flows during rotation of the rotor device (10; 20),
wherein at least one surface section of the inner surface has a microchannel structure (34; 44; 64), the channels (35; 45; 65) of which extend at a distance d of adjacent channels, in particular where d<2 mm.

15. Centrifuge (1), having a rotor device (10; 20) according to claim 1.

16. Method for producing a rotor device according to any claim 1, wherein the channel structure is produced by surface processing or by a casting method, in particular by printing the microchannel structure on the outer surface or inner surface, or by applying a film having this microchannel structure.

17. Centrifuge bowl according to claim 14, wherein the channel structure is produced by surface processing or by a casting method, in particular by printing the microchannel structure on the outer surface or inner surface, or by applying a film having this microchannel structure.
